(19) United States
(12) Patent Application Publication
(10) Pub. No.: US 2018/0204437 A1
(43) Pub. Date: Jul. 19, 2018

(54) METHOD AND SYSTEM FOR PROVIDING ALERTS TO A COMPUTING DEVICE

(71) Applicant: Samsung Electronics Co., Ltd., Suwon-si (KR)

(72) Inventors: Amitoj SINGH, Noida (IN); Varad ARYA, Noida (IN); Arun PRABHAKAR, Noida (IN); Govind JANARDHANAN, Noida (IN); Ishani GHOSH, Noida (IN); Pooja PAWWAR, Noida (IN); Ekta Anil Pradeep SACHDEV, Noida (IN); Ridhima JAISWAL, Noida (IN); Anupam BHARDWAJ, Noida (IN); Manoj KUMAR, Noida (IN); Ritesh SINHA, Noida (IN); Kumar Anurag SINGH, Noida (IN); Manish KUMAR, Noida (IN); Naresh Kumar GUPTA, Noida (IN); Santosh Pallav SAHU, Noida (IN); Tasleem ARIF, Noida (IN); Vipin TIWARI, Noida (IN); Vivek KUMAR, Noida (IN)

(21) Appl. No.: 15/873,491

(22) Filed: Jan. 17, 2018

(30) Foreign Application Priority Data
Jan. 18, 2017 (IN) 201711002020

(51) Int. Cl. G08B 21/02; G06K 9/00; G06F 11/34; H04W 4/02

(52) U.S. Cl. CPC G08B 21/02; H04W 4/027; G06F 11/3438; G06K 9/00348

(57) ABSTRACT

A method and a system for providing alerts at a computing device are provided. The method as executed by the system includes determining usage of the computing device based on a user interaction. Ascertaining whether the user is exhibiting a foot movement. Displaying an overlay of a predetermined size for a predetermined amount of time to cause an alert, in response to the ascertainment and the determination. Incrementing a size of the displayed overlay linearly with time, based on persistence of the usage and said exhibition of the foot movement beyond an extended time duration.

### CROSS-REFERENCE TO RELATED APPLICATION(S)

This application claims the benefit under 35 U.S.C. § 119(a) of an Indian Provisional patent application filed on Jan. 18, 2017 in the Indian Intellectual Property Office and assigned Serial number 201711002020 and of an Indian Complete patent application filed on May 17, 2017 in the Indian Intellectual Property Office and assigned Serial number 201711002020, the entire disclosure of each of which is hereby incorporated by reference.

### TECHNICAL FIELD

The present disclosure relates to a mobile device, and in particular, relates to alert providing mechanisms within the mobile device.

### BACKGROUND

Distracted walking is a growing contemporary phenomenon due to a simultaneous usage of a mobile device while walking. Engrossment in operating a mobile device while walking can lead to visual, auditory, spatial and cognitive distractions to the user, and accordingly subject the user to increased risks in dangerous situations.

The growth of displayable content within the mobile devices and increased data speeds have further led to increased engagement with the devices. The race to stay updated leads to users giving precedence to the mobile devices ahead of their immediate surroundings, even during walking or indulging in outdoor activities. Taking into consideration walking as an outdoor activity, it doesn't have a predefined start or stop. Owing to the walking being an indefinite phenomenon, the users may remain even oblivious of the fact that they are currently exhibiting a ‘distracted’ walking and in turn remain unaware of the adverse repercussions. The effects of distracted walking range from more frequent phone drops/tripping to as lethal as severe road accidents and fatalities.

Accordingly, there has been a long-felt need of a mobile device that is capable of automatically alerting a user in real time about imminent dangers, owing to a continuous usage of the mobile device by a walking user.

There has been another long-felt need of a mobile device that automatically configures an ongoing mobile device operation in real time, based on sensing imminent dangers due to continuous usage of mobile device by a walking user.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and system for providing alerts at a computing device.

In accordance with an aspect of the present disclosure, a method and system for providing alerts at a computing device is provided. The method as executed by the system includes determining usage of the computing device based on a user interaction. Ascertaining whether the user is exhibiting a foot movement. Displaying an overlay of a predetermined size for a predetermined amount of time to cause an alert, in response to the ascertainment and the determination. Incrementing a size of the displayed overlay linearly with time, based on persistence of the usage and said exhibition of the foot movement beyond an extended time duration.

In accordance with another aspect of the present disclosure, a method for sending alerts to a through his/her mobile device is provided. The method includes sensing a motion exhibited by the mobile device user along with a usage of mobile—device. Based on the sensed motion for a particular time period, the user is sent alerts to refrain from either using said mobile device or halt the motion as exhibited by the user.

In an implementation, the intensity and communication of such alerts varies depending upon the nature of motion as exhibited by the user and/or an immediate neighborhood of the user.

In other implementation, the communication of alerts includes influencing operation of the mobile device and various other accessory devices which are linked with the mobile device and currently being used in conjunction with the mobile device, during the exhibition of the motion by the user.

Based upon the aforesaid sensing as performed, the method further comprises influencing an operation of the mobile device through at least one of restriction or suppression of an ongoing operation, and Generation of a fresh or modified user interface to restrict the usage of the mobile device only in terms of meeting urgent requirements.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 shows method steps for providing alerts according to an embodiment of the present disclosure;

FIG. 2 shows a detailed internal construction of the system for providing alerts according to an embodiment of the present disclosure;

FIGS. 3A and 3B show implementations of method steps of FIG. 1 according to various embodiments of the present disclosure;

FIG. 4 shows a variation of alerts as depicted at the mobile device according to an embodiment of the present disclosure;

FIGS. 5A, 5B, and 5C show variations of alerts in the overlay size in the increasing order according to various embodiments of the present disclosure;

FIG. 6 shows a variation of alerts in the overlay size in the decreasing order another implementation according to an embodiment of the present disclosure;

FIG. 7 illustrates another implementation by detecting geographical coordinates of the user according to an embodiment of the present disclosure;

FIGS. 8A and 8B illustrate implementations of displaying data as logged during the active state of the mobile device according to various embodiments of the present disclosure;

FIGS. 9A and 9B show variations of alerts according to various embodiments of the present disclosure;

FIGS. 10A, 10B, and 10C show variations of alerts according to various embodiments of the present disclosure;

FIGS. 11A, 11B, and 11C illustrate functionalities of the user interfaces during the activate state of the overlays according to various embodiments of the present disclosure;

FIGS. 12A and 12B illustrate locations of display of overlay according to various embodiments of the present disclosure;

FIG. 13 illustrates a specific modular implementation of the system for providing alerts of FIG. 2 according to an embodiment of the present disclosure; and

FIG. 14 depicts a computing device based implementation of FIG. 2 according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or subsystems or elements or structures or components proceeded by “comprises._{—} a” does not, without more constraints, preclude the existence of other devices or other subsystems or other elements or other structures or other components or additional devices or additional subsystems or additional elements or additional structures or additional components.

Unless otherwise defined, all technical and scientific terms used herein have the same meaning as commonly understood by one of ordinary skill in the art to which this disclosure belongs. The system, methods, and examples provided herein are illustrative only and not intended to be limiting.

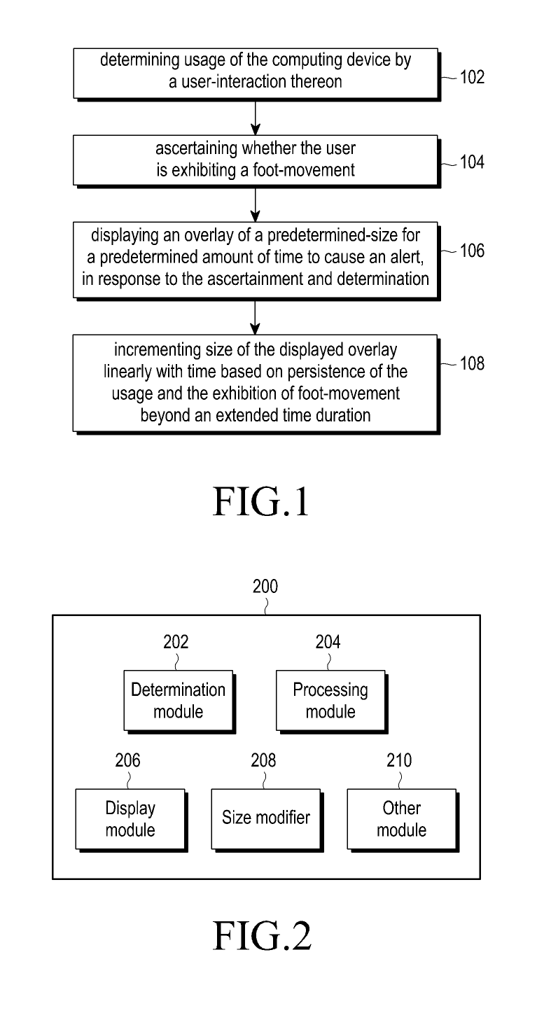

FIG. 1 shows method steps for providing alerts according to an embodiment of the present disclosure.

Referring to FIG. 1, it can be seen that the present disclosure, in accordance with a first embodiment, provides method for providing alerts at a. computing device. The method comprises determining in operation 102 usage of the computing device at least through a user interaction thereon.

The usage of the computing device by the user interaction is determined by said user's interaction through capturing a duration of the user's gaze or face pointing towards a location at a screen area: a number of times the user blinks the eve lids while viewing the screen area, a type and number of user inputs as received (e.g. typed) through a keypad, an audio/video being rendered at the device; and execution of communication (e.g. phone calls, messaging or any other equivalent communication) by the user through the device.

The method further comprises ascertaining in operation 104 during said determining, if the user is exhibiting a foot movement through taking operations, wherein said ascertainment of foot movement is enabled by at least one of motion sensors, accelerometer, pedometer, global positioning system (GPS) chipset, or a combination thereof within the computing device. Such ascertainment of foot movement comprises differentiating the user's motion from a vehicle imparted motion based on detecting a footstep count and geographical coordinates corresponding to the user, capturing the user's footstep pattern as executed among at least one of: walking, running, jogging, driving, and determining the user's gait at least based on a footstep count; and utilizing a location based application programming interface (API) to detect the user's travel in a moving vehicle and ignoring, at least partly, the footsteps as exhibited by said user during such vehicle movement.

In response to said ascertainment and determination, the computing device may be configured to inform the user about a surrounding geographical area, filter the information presented through the mobile device to minimize user attention, modify the display to enable see through viewing so as to give the appearance of seeing through the computing device, modify the user interface to substantially limit instructions capable of being inputted by the user, automatically triggering one or more functionalities of the computing device, and momentarily restrict one or more functionalities otherwise dischargeable by the computing device.

Further, the method comprises displaying in operation 106 an overlay of a predetermined size for a predetermined amount of time to cause an alert, in response to said ascertainment and determination. More specifically, the overlay exhibits a plurality of sizes based on incrementing and decrementing, sizes, and facilitates alerting through such multi-sized overlays, as long as there is continuous persistence of the usage of the mobile device and the exhibition of foot movement from the user.

Further, the display of overlay is accompanied by allowance of the computing device's operations during the exhibition of foot movement executed under a first type of scenarios (e.g. non-serious scenarios such as walking alone in a park), blockage of the computing device's operations during the exhibition of foot movement executed under one or more second type of scenarios (i.e. serious scenarios such as crossing the road), depiction of one or more shortlisted functionalities of the computing device at the screen area to enforce minimize user interaction; and modification of a format of information usually displayed by the computing device into a different format (e.g. conversion of text message into speech to expedite grasp by the user)

Based on the continued persistence of said usage and the exhibition of the overlay beyond a threshold time duration, the overlay is flashed across the entire screen of the device at least for a split second and thereafter restored by a display of the ‘overlay size’ as had been exhibited prior to said flashing, i.e. 4×. In other words, overlay gets restored to the last depicted size.

Further, the method comprises incrementing in operation 108 size of the said displayed overlay linearly with time, based on persistence of said usage and said exhibition of the foot movement beyond an extended time duration.

In addition to the aforesaid, the method further comprises storing a screen position of the displayed overlay in a database and thereafter fetching said stored screen position of the overlay from the database so as to render said overlay at the same screen position as and when the display of the overlay happens next time. In another example, said screen position for displaying the overlay is modifiable through the user inputs. For example, the screen overlay may be dragged and dropped to new position to cause appearance at the new position henceforth.

Further, a number of steps executed through foot movement may be classified as safe steps in case of absence of the usage of the computing device as a part of said user interaction. As and when said plurality of safe steps exceed a threshold value, the user of the computing device may be designated or awarded through electronic messages. Otherwise, the persistence of the usage of the computing device through said user interaction leads to classification as unsafe steps.

Further, a representation of incoming notifications may be modified within the mobile device based on persistence of the usage of the mobile device through the user interaction and the exhibition of foot movement through the steps. In an example, the incoming notification may be merely indicated as having been arrived in terms of ‘numerical figures’, instead of depicting entire details.

In an example, the user may be also allowed to momentarily suspend the display of the overlay based on his discretion input so as to complete urgent tasks in hand.

FIG. 2 illustrates a detailed internal construction of a system 200 according to an embodiment of the present disclosure.

The system 200 includes a determination module 202 that performs the operation 102, a processing module 204 that performs the operation 104, a display module 206 that performs the operation 106, and a size modifier 208 that performs the operation 108. Likewise, there may be other modules 210 within the system 200 that facilitate the operational interconnection among the modules 202 till 208, and perform other ancillary functions.

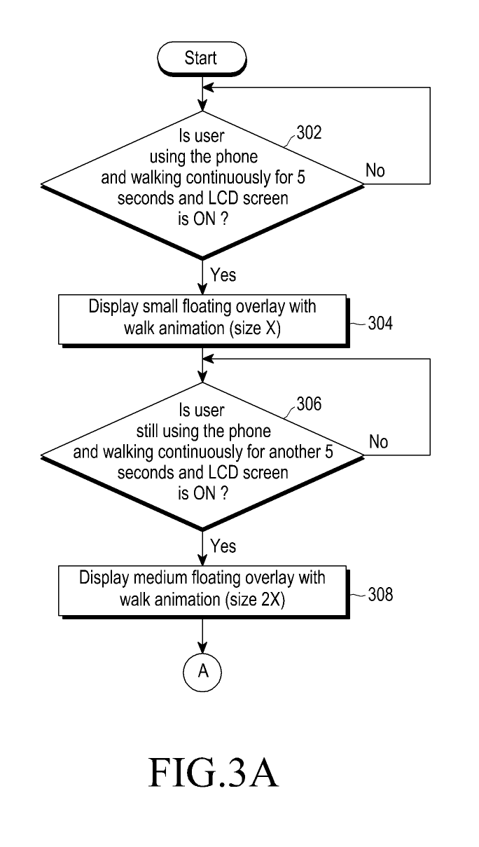

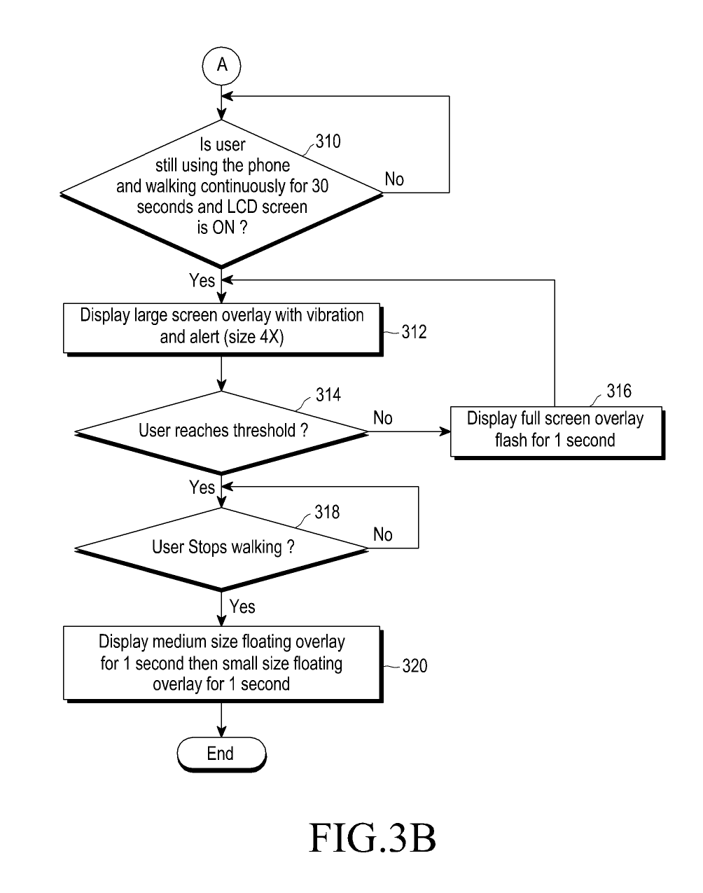

FIGS. 3A and 3B show implementations of method steps of FIG. 1 according to various embodiments of the disclosure.

More specifically, as depicted in operation 302 of FIG. 3A, whenever the mobile device is in use (e.g. liquid crystal display (LCD) screen ON for more than 5 second) by the user and a simultaneous walking/motion as exhibited by the user is detected, a walk animation as a floating overlay is displayed above an ongoing activity; within the mobile device as a result in the operation 304.

While the operation performed through the mobile device isn't interrupted, yet the overlay displayed over the mobile device provides a constant reminder to the user to either stop walking or refrain from using the phone while walking. The size of such overlay increases (say twice) as depicted in operation 308, based on the condition as depicted in operation 306 that the user is persisting with walking and using the mobile device (say for another 5 seconds).

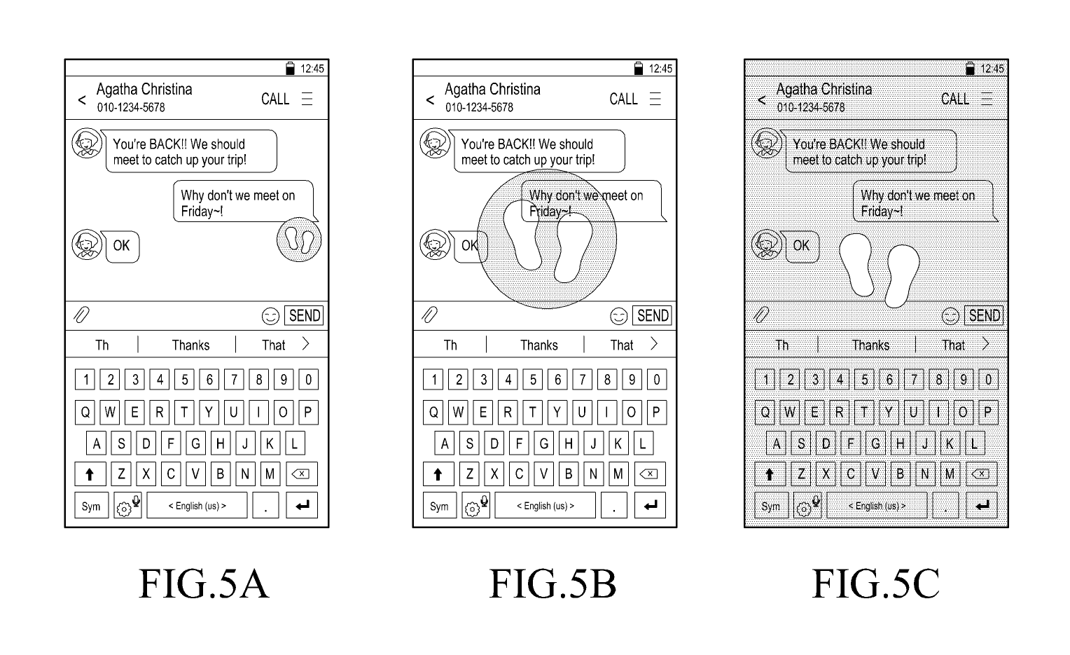

Despite the aforesaid twice increment in overlay size, in case the user still persists with the existing activities for an additional predefined time period say 30 seconds as depicted in operation 310 of FIG. 3B, then the size of the overlay increases further (say 4 times the initial most size as depicted in operation 312) enough to obscure a major portion of the display of the mobile device (as mentioned later in FIG. 5B). Such hindering of display persists as long as the user maintains the existing activities.

Still further, in the user persists with the usage with no break and a threshold time gets exceeded as depicted in operation 314, then the overlay occupies the entire screen area and flashes momentarily say for a second as depicted in operation 316. Upon having flashed once, the overlay returns to the size of operation 312. However, owing to further persistence of usage, the flashing depicted in operation 316 keeps on happening intermittently.

However, in case the user initiates an abstinence by either halting the walking or withdrawing from using the mobile device during walking as shown in operation 318, then the size of the overlay that about 4X starts reducing gradually and sequentially from the 4× to 2× and then to 1×, and eventually vanishes as depicted in operation 320.

While each of the operations 302, 306, 310, 314 and 318 represent the combination of operations 102 and 104, the operation 304 represents the operation 106 and the remaining operations 308, 312 and 316 represent ‘the operation 108. Operation 320 represents an inverted version of operation 108.

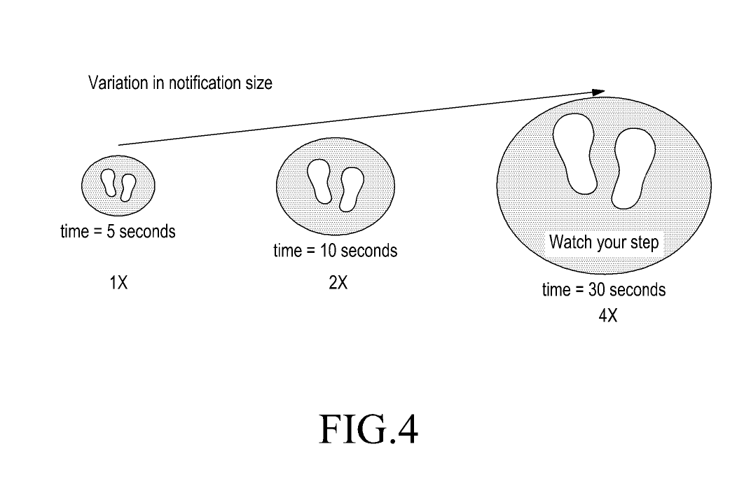

FIG. 4 diagrammatically illustrates a variation of alert as depicted at the mobile device, in accordance with the description provided in FIG. 1 according to an embodiment of the present disclosure. More specifically, FIG. 4 represents an overlay as discussed in FIG. 1 to FIG. 3, such that overlay varies its size from 1× to 4× as depicted in operations 304, 308 and 312.

FIGS. 5A, 5B, and 5C also diagrammatically represent such variations in the overlay size in the increasing order with respect to the screen of mobile/computing device according to various embodiments of the present disclosure, such that FIGS. 5A, 5B and 5C respectively represent operations 304, 308 and 316.

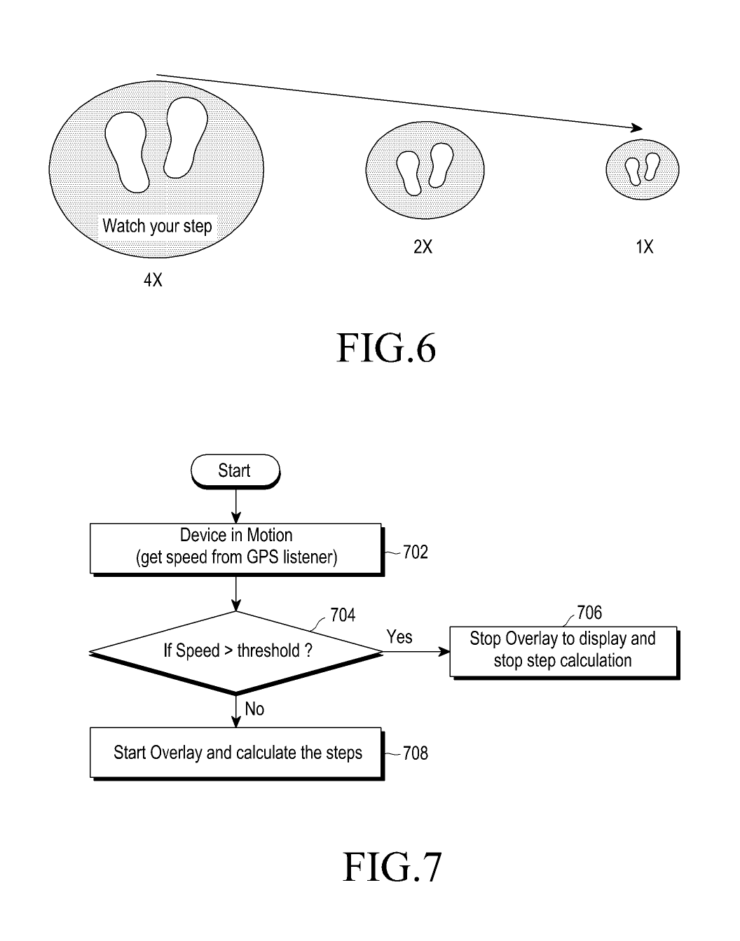

FIG. 6 shows a variation of alerts in the overlay size in the decreasing order another implementation according to an embodiment of the present disclosure.

Likewise, as shown in the FIG. 6, the overlay size also gradually decreases in the reverse order. As may be understood, such decrement collectively represents the operation 320.

FIG. 7 depicts another implementation according to an embodiment of the present disclosure, wherein motion sensors or inertial sensor such as using pedometer/accelerometer/gyroscopes values are used to detect a step count and geographical coordinates of the user, as depicted in the operation 702.

More specifically, it is detected as to whether the user is exhibiting different activities such as walking, running, jogging, driving, etc., based on learning the user's gait pattern over a period of time. In case the speed or velocity of the user exceeds a threshold value, as detected at operation 704, and if its determined that there is a significant variation in the user's geographical coordinates, then it may be ascertained that the user is undergoing a motion due to travel in a vehicle and due to his own self.

In an example of the operation 704, a GPS module determines whether the device is moving at a speed greater than a first predetermined threshold (more than walking speed) in order to differentiate with traveling in a motor vehicle. In other words, it is seen if the ‘GPS measured locations’ undergo a continuous change, while detecting the speed/velocity/frequency of steps in context of the user.

In case the detection in operation 704 is positive, then the frequency of steps undertaken by the user and/or exhibited velocities are ignored and accordingly no overlay is rendered as per operation 706. In such a scenario, even an existing overlay is also subverted, owing to the user current presence in the vehicle. In an example, an overlay as would have developed owing to a user's running attempt to catch the bus is withdrawn soon upon having detected the user's presence in the bus.

Further, in case of a bonafide motion (running, walking, jogging) detected with respect to the user, the overlay is either maintained or imposed within the display, as per operation 706.

Further, the operations 702, 704 and 708 represent the operations 102, 104 and 106 of FIG. 1.

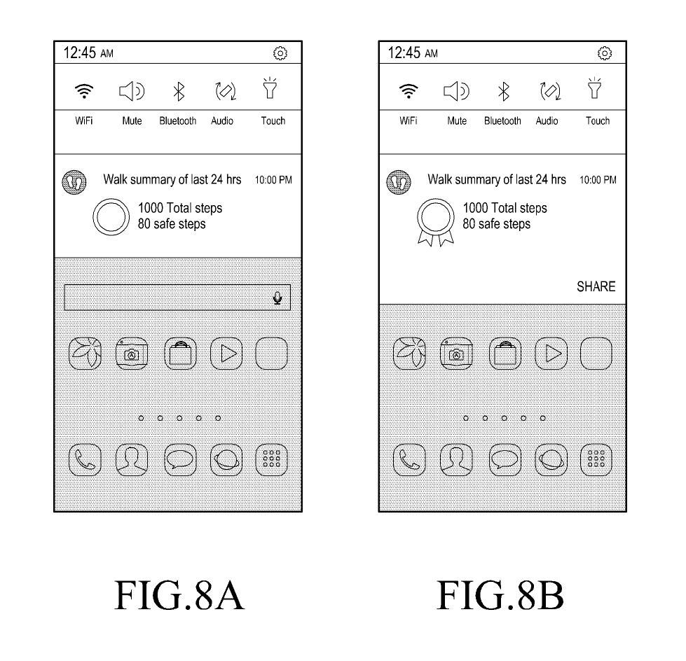

FIGS. 8A and 813 represent displaying data as logged during the active state of the mobile device according to various embodiments of the present disclosure.

More specifically, as depicted in FIGS. 8A and 8B, the mobile device user is facilitated to view their daily/weekly/fortnightly walking summary as a. notification. The walking summary may be captured based on the detection of motion by the mobile device as had been already explained with respect to preceding figures. In an example, the total steps undertaken by the user and a number of safe steps are displayed. Safe steps may be the steps taken by the user, as detected by the mobile device, while the user is not actively engaged with the mobile device.

As depicted in FIGS. 8A and 8B, the user may also be rewarded for safe walking along with shareable badges. Safe walking may be determined as 80% safe steps as undertaken by the user. A socially networked aspect of the present feature motivates the users to engage in safer walking to earn more badges and accordingly exit the growing list of distracted walkers.

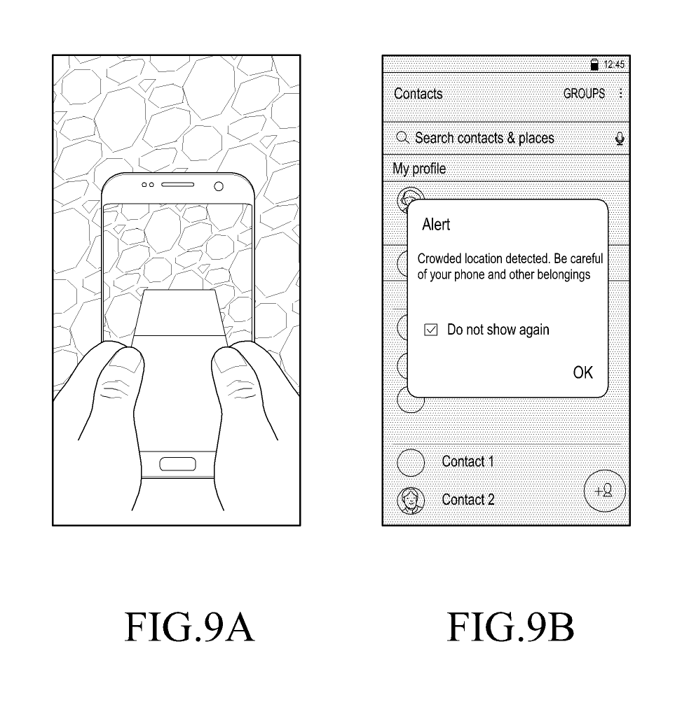

Further, description of forthcoming FIGS. 9A and 9B, 10A to 10C, 11A to 11C, and 12A and 12B providing additional alerts and providing context and risk specific interactions. This may be achieved based on following parameters:

a) Identification of the external situation and environment currently surrounding the user by capturing of surroundings' data from online databases, e.g. based on GPS chipset (& online Maps) and device sensors.

b) Identification of the activity that the user is performing on the device and analysis of the risks associated with that activity, as based on the external situation as identified.

FIGS. 9A and 9B illustrate depictions of alerts according to various embodiments of the present disclosure.

As depicted in FIG. 9A, a tilted screen view is created whenever the device is held horizontally while walking, thereby giving the user a partial view of the risks (i.e. obstacles placed upon the road) lying head and rendering the user activity over the mobile device difficult owing to a shortened user interface. Accordingly, a time which otherwise would have been spent by the walking user upon operating the phone is substantially reduced.

More specifically, when users use mobile devices while walking, the device is primarily horizontal and the view of the user is directed downwards, i.e. towards the floor. Accordingly, the users become usually unaware of any upcoming dangers, e.g. stones lying on the road or a pit dug within the road. In such a scenario, the tilted screen view enables the user to see through the road or street surface via the camera action of the mobile device. Further, the mobile device returns from the tilted screen to a normal view when the device is again help up vertically.

Further, as depicted in FIG. 9B, the mobile device can extract local area information like crime trackers (through accessing the internee) and warn the user for all possible threats.

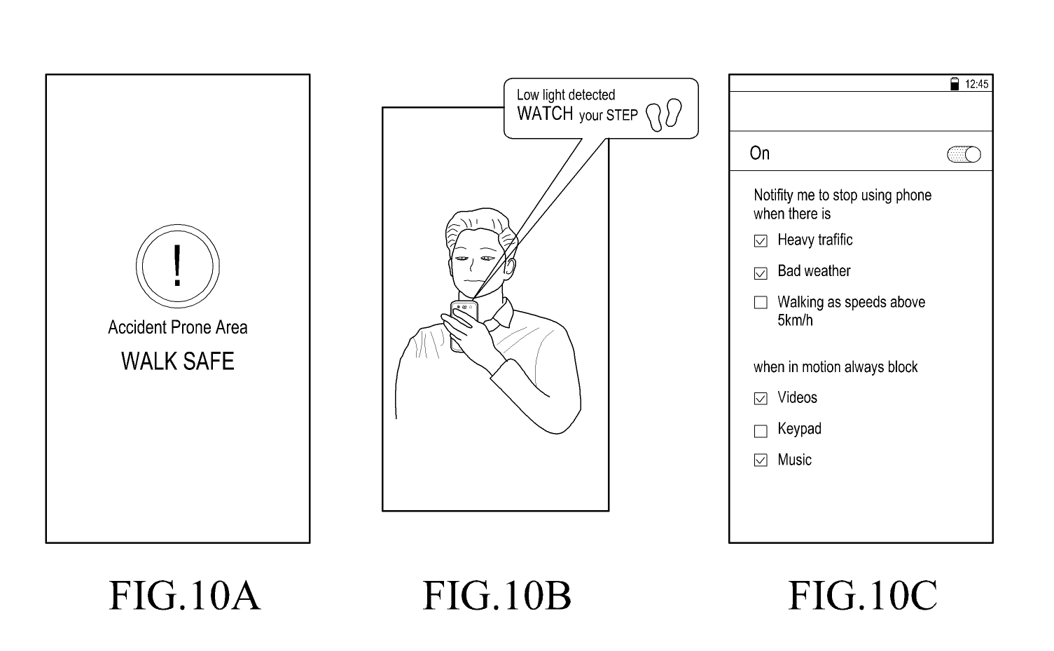

FIGS. 10A to 10C illustrate depictions of alerts according to various embodiments of the present disclosure.

As depicted in FIG. 10A, upon having gathered information that a particular area is accident prone, the mobile device carried by the walking user pauses or suspends all activities unless the user has either walked past the theft prone area or stopped either a usage of the mobile device or walking within the theft prone area,

As depicted in FIG. 10B, in case the mobile device is active while the user walks past the areas having low illumination/ switched off streetlights/absent streetlights, the mobile device may alert the user to exercise caution while walking and also automatically enable the torch operation.

As depicted in FIG. 10C, a user interface may be provided for customization of the alerts to be automatically received during the usage of mobile device. For example, the user may request overlays to restrain mobile usage in bad weather conditions, heavy traffic, etc. Additional, the user may also request list of applications that shall be blocked as and when the overlays are active. In an example, the user may request blockage of videos and music during said scenarios. In this way, the user may be provided a hand in selectively restricting the mobile device activities during the overlay depiction, that in turn may be also based on events selected by the user.

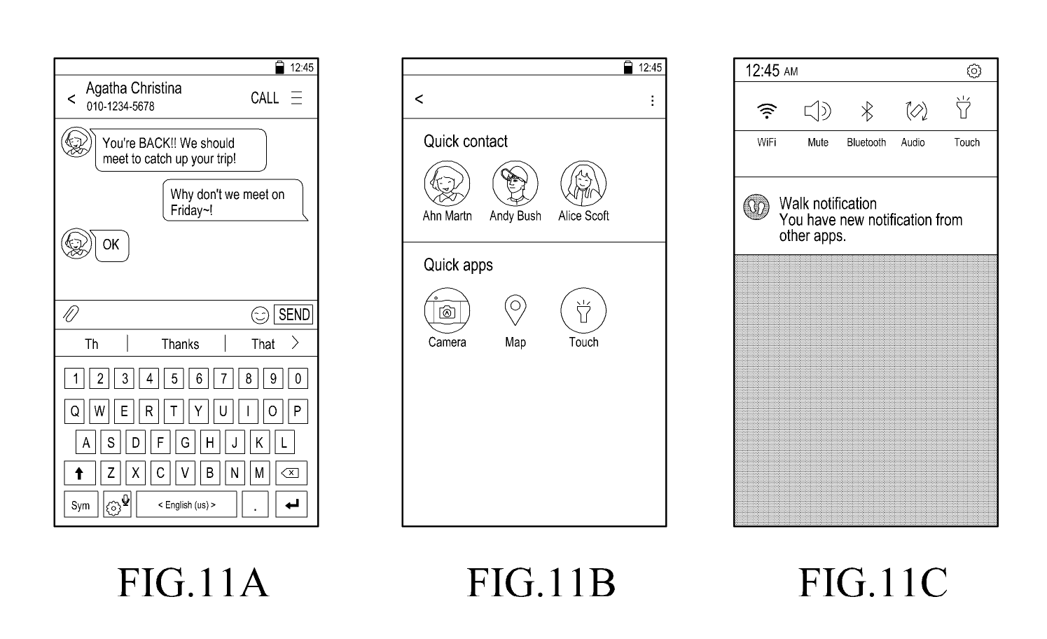

FIGS. 11A to 11C depict implementations of the present disclosure, wherein the functionality of the user interfaces such as short message service (SMS) typing window, list of contact members, and notification receipt by the mobile device have been restricted during the activate state of the overlays according to various embodiments of the present disclosure.

For example, the restrictions as depicted through FIG. 11a and 11b denote that not more than 50 letters may be typed as an SMS, and only selected contacts are displayed within the contact list (to limit the user driven communication to important contacts only). As depicted in FIG. 11c, notifications received by the mobile device may be only shown in terms of number of notifications, instead of depicting details or preview of such notification. Moreover, the notifications may also be rendered useful to access the correspondingly hidden messages, only after the overlay gets removed from the computing device.

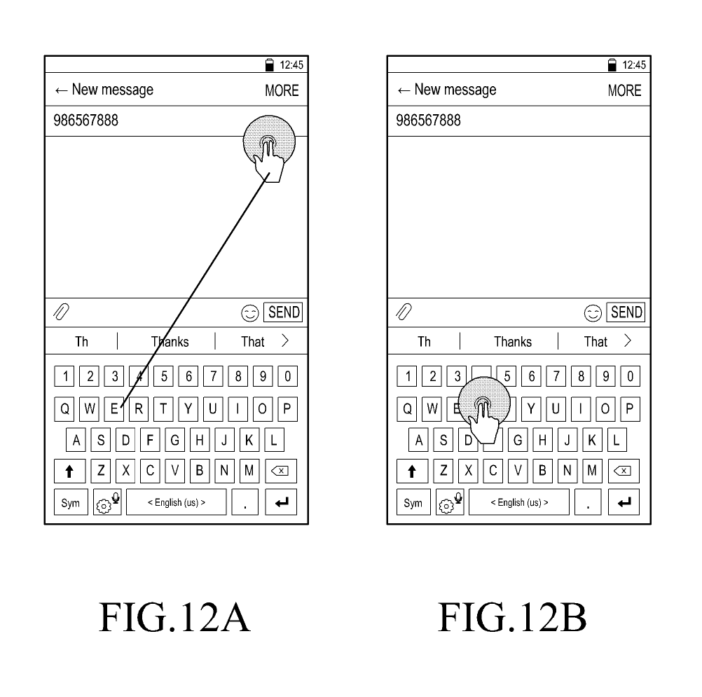

FIGS. 12A and 12B depict implementations of the present subject matter, wherein the location of display of overlay may be altered by the user according to various embodiments of the present disclosure.

As depicted in FIG. 12A, the overlay may appear based at a default location. Based on a drag and drop action, the location of the overlay display may be shifted to another location as depicted in FIG. 12B.

In addition to the implementations as covered under FIGS. 3A, 3B, 4, 5A, 5B, 5C, 6, 7, 8A, 8B, 9A, 9B, 10A, 10B, 10C, 11A, 11B, 11C, 12A, and 12B, other types of alert based and mobile device restriction (partial or entire) based implementations are have been enumerated as follows:

a) in case user is playing any game while walking and the device detects a busy traffic (based on GPS data) ahead, the game can be paused till the user stops or the traffic eases.

b) Preemptive blocking of dangerous activities like watching videos, using earphones, etc., may be done, when the device detects that user is using the mobile device while walking on a busy road.

c) Using Honk detection feature, the mobile device can pause audio signals within the earphone, in case the user is using earphones or headphones in conjunction with the mobile device. In such a scenario, the mobile device detects the external horn sound and routes it to the earphones, thereby warning the user about approaching vehicle or danger. Alongside, the mobile device screen may also provide a visual alert corresponding to the blown horn,

The concept behind horn detection is to bring the focus of the user back to his/her ambience in case any horn is detected in the close vicinity. This is a safety feature for people walking on the roads/streets being too involved in their mobile phones.

In operation, an audio input source (e.g. microphone (MIC)) collects the ambient sound and presents it to a horn detection engine which, with the help of a frequency sampler, identifies the zero crossing value (ZCV) of the sample raw audio data. Based on the running average of every two consecutive samples' ZCV, if it is below a threshold value, a horn detection is notified. Accordingly, the user is intimated by displaying a screen overlay. If the user has the earphones connected, then an audio warning is also played.

d) When the user continues to use their phone for extended durations while walking, the active screen can freeze momentarily and display a short screensaver or a translucent overlay on the screen. This will help the user snap out of the trance of using the mobile device.

In case the user is using the keypad (i.e. typing) while walking, the keypad properties can be updated to suit the scenario. The contrast can be increased to improve visibility of characters, since the user is walking and the device is prone to shaking. Additionally, the character input limit can be reduced to limit texting while walking, or a dictionary can prompt quick abbreviations and emoticons for swift communications.

f) Further, apart from the detecting the user walking, the mobile device may also be configured to detect a fall (Accident) and automatically sending a SMS to predefined mobile station international subscriber directory number (MSISDN) as set by the user.

g) A wearable device (such as a smart watch or a virtual reality/augmented reality headgear) linked to the main computing device may also be also provided with overlay or alerts for assisting the user.

h) The mobile device may be completely blocked from usage upon sensing the user being preoccupied with serious scenarios. For example, upon having sensed that the user is climbing up or down the stairs or crossing a busy street with heavy traffic, the phone may be completely blocked from usage. This is so since any engagement of the user by the mobile device during such scenarios may be catastrophic or life threatening. Yet, a handful of essential functions may be still rendered active through the mobile device such as panic button, SOS message function etc.

i) Further, the mobile devices may also be communicated alerts from various electromechanical devices connected to the internet (based on implementation of the ‘internet of things’ based concept). For example, the mobile device may be overlaid with the graphic indicator in case a washing machine running within the house has ended its operation and now requires user to vacate the same. Likewise, an electric fan which is running for quite some time may automatically overlay the mobile device with alerts to prompt the user at switching off the electricity supply to save power.

j) Likewise, the mobile device may also automatically log the user's daily activities and may provide overlay based alerts at a particular time when there is a high probability that the user is going to be engaged in an important task. For example, a user engaged in sports daily between 6 to 7 PM may be alerted through overlays to leave the mobile device and get engaged in the usual sports activities at such points of time every day. Such automatic logging of information and sending of the alerts may be assisted by way of an artificial intelligence based configuration implemented within the device.

Continuing with further examples, the displayed overlay as provided with be contrasted enough from the background/ongoing display using any recommended color combinations as known in the art.

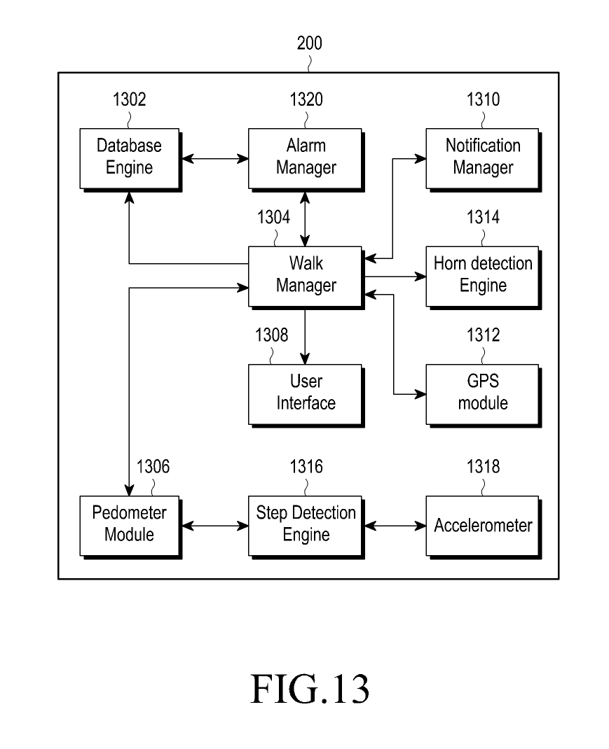

FIG. 13 depicts a specific modular implementation of the system as depicted in FIG. 2 according to an embodiment of the present disclosure. More specifically, FIG.13 further elaborates a hardware implementation of FIG. 2 in terms of modules and various sub modules depicted as follows.

A database engine 1302 stores the user's step data as collected due to the foot movement and represents the module 210.

A walk manager 1304, representing the processing module 204 and the size modifier 208 is a central unit connected to a pedometer module 1306 (representing the processing module 204) and sends the message to a user interface 1308 and a display service to display animation on device screen. The walk manager 1304 collects the data from the pedometer module 1306 and updates database accordingly. This database is also used to maintain the user's walk history of last month.

The pedometer module 1306 may be assisted by a background service running concurrently at the operating system to monitor the walk steps and extracting data from the pedometer. The background service also handles the displayed animation's intermediate steps while the device is in motion and in use by the user.

A notification module 1310 (representing the display module 206) is used to hide all incoming notification while user is walking, as depicted in FIG. 11C. This module 1310 calculates the incoming notification and displays a count of incoming notification instead of showing the content of the notification, thereby restraining the user from using the device while walking. As explained aforesaid, only when the user stops the usage of the mobile device, then only the notification could be expanded and the contents seen.

A GPS module 1312 (representing the processing module 204) provides the location change information with respect to the user to the walk manager 1304. Once the user location is changed, then user speed and motion detected as per the criteria provided at step of FIG. 7. Such criteria based comparisons are used for the purposes of detecting whether the user is actually waking or running, without any ant vehicular support. Accordingly, the faulty steps otherwise detected during the travel in vehicle are ignored.

A horn detection module 1314 (representing the determining module 202) starts recording the audio to get an ambient sound and filters it to detect the horn sound presence. If the horn is detected, then the user is alerted by various method, notification, vibration, Audio alert by playing the voice message etc.

The aforesaid pedometer module 1306 itself is a modular system comprising pedometer manager, pedometer library, pedometer notification, pedometer data, etc. The submodules mainly use the accelerometer sensors data and convert into the walk steps according to the user's physical information. This module 1306 provides the data to the background service and the walk manager. For example, the pedometer manager interacts with the walk manager 1304 and a step detection engine 1316 to provide the step data to the walk manager.

The step detection engine 1316 reads an accelerometer 1318 provided reading and based on the predefined parameters, categorizes the movements into walking step, running step, cycling, etc. Both the step detection engine 1316 and the accelerometer 1318 represent the processing module 204.

The walking/running steps are further categorized into following categories:
Safe steps: Steps taken when the screen on OFF.
Unsafe steps: Steps taken when the screen was ON.

The step detection engine 1316 updates the step based data into two ways:
Real time update: Steps are determined continuously and are updated to the walk manager 1304 step by step.
Batch update: Steps are determined continuously but updated to the walk manager 1304 when the user stops.

All the safe steps are being updated as a batch update in attempt to reduce the battery consumption. On the other hand, the unsafe steps are updated in real time so as to intimate the user about unsafe steps being taken via a screen overlay.

An alarm manager 1320 communicates with the database engine 1302 and walk manager 1304, and provides an alarm function.

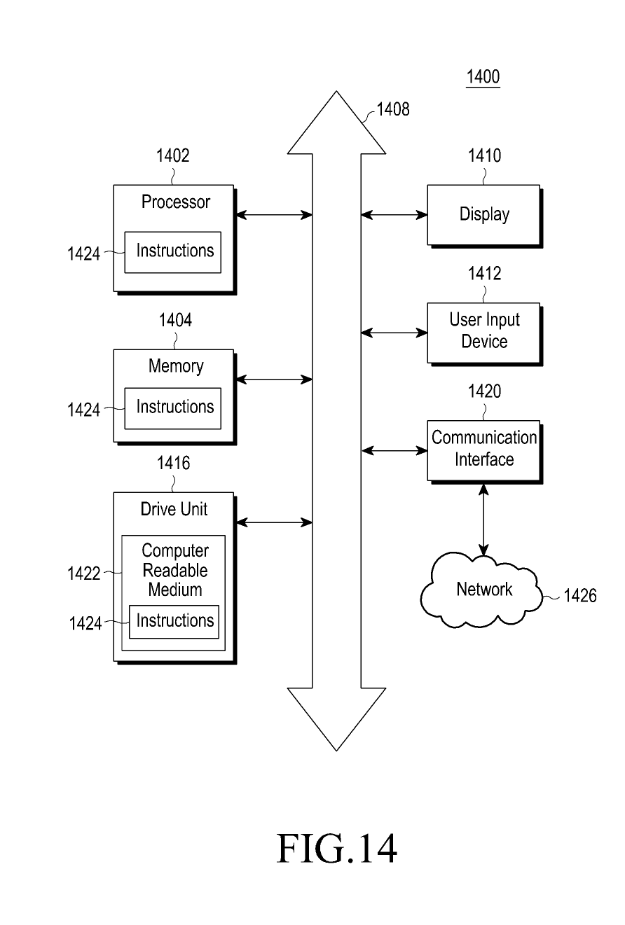

FIG. 14 shows yet another implementation according to an embodiment of the disclosure; and yet another typical hardware configuration of the system 200 in the form of a computer system 1400 is shown.

The computer system 1400 can include a set of instructions that can be executed to cause the computer system 1400 to perform any one or more of the methods disclosed. The computer system 1400 may operate as a standalone device or may he connected, e.g., using a network, to other computer systems or peripheral devices.

In a networked deployment, the computer system 1400 may operate in the capacity of a server or as a client user computer in a server client user network environment, or as a peer computer system in a peer-to-peer (or distributed) network environment. The computer system 1400 can also be implemented as or incorporated across various devices, such as a personal computer (PC), a tablet PC, a personal digital assistant (PDA), a mobile device, a palmtop computer, a laptop computer, a desktop computer, a communications device, a wireless telephone, a landline telephone having a touch screen user interface, e, or any other machine capable of executing a set of instructions (sequential or otherwise) that specify actions to be taken by that machine. In a preferred implementation, the computer system 200 may be a mobile computing device capable of being worn by a user, e.g. a smartwatch, an augmented reality headgear, a wearable mobile phone etc. Further, while a single computer system 1400 is illustrated, the term “system” shall also be taken to include any collection of systems or subsystems that individually or jointly execute a set, or multiple sets, of instructions to perform one or more computer functions.

The computer system 1400 may include a processor 1402 e.g., a central processing unit (CPU), a graphics processing unit (GPU), or both. The processor 1402 may be a component in a variety of systems. For example, the processor 1402 may be part of a standard personal computer or a workstation. The processor 1402 may be one or more general processors, digital signal processors, application specific integrated circuits, field programmable gate arrays, servers, networks, digital circuits, analog circuits, combinations thereof, or other now known or later developed devices for analyzing and processing data. The processor 1402 may implement a software program, such as code generated manually (i.e., programmed).

The computer system 1400 may include a memory 1404, such as a memory 1404 that can communicate via a bus 1408. The memory 1404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1404 includes a cache or random access memory for the processor 1402. :In alternative examples, the memory 1404 is separate from the processor 1402, such as a cache memory of a processor, the system memory, or other memory. The memory 1404 may be an external storage device or database for storing data. The memory 1404 is operable to store instructions executable by the processor 1402. The functions, acts or tasks illustrated in the figures or described may be performed by the programmed processor 1402 executing the instructions stored in the memory 1404. The functions, acts or tasks are independent of the particular type of instructions set, storage media, processor or processing strategy and may be performed by software, hardware, integrated circuits, firmware, microcode and the like, operating alone or in combination. Likewise, processing strategies may include multiprocessing, multitasking, parallel processing and the like.

As shown, the computer system 1400 may or may not further include a touch sensitive display 1410, for outputting determined information as well as receiving a user's touch gesture based inputs, such as drag and drop, single tap, multiple taps, etc. The display 1410 may act as an interface for the user to see the functioning of the processor 1402, or specifically as an interface with the software stored in the memory 1404 or in the drive unit 1416.

Additionally, the computer system 1400 may include an input device 1412 configured to allow a user to interact with any of the components of system 1400. The computer system 1400 may also include a disk or optical drive unit 1416. The disk drive unit 1416 may include a non-transitory computer readable medium 1422 in which one or more sets of instructions 1424, e.g. software, can be embedded. Further, the instructions 1424 may embody one or more of the methods or logic as described. In a particular example, the instructions 1424 may reside completely, or at least partially, within the memory 1404 or within the processor 1402 during execution by the computer system 1400.

The present disclosure contemplates a computer readable medium that includes instructions 1424 or receives and executes instructions 1424 responsive to a propagated signal so that a device connected to a network 1426 can communicate voice, video, audio, images or any other data over the network 1426. Further, the instructions 1424 may be transmitted or received over the network 1426 via a communication port or interface 1420 or using a bus 1108. The communication port or interface 1420 may be a part of the processor 1402 or may be a separate component. The communication port 1420 may be created in software or may be a physical connection in hardware. The communication port 1420 may be configured to connect with a network 1426, external media, the display 1410, or any other components in system 1400, or combinations thereof. The connection with the network 1426 may be established wirelessly as discussed later. Likewise, the additional connections with other components of the system 1400 may be established wirelessly. The network 1426 may alternatively be directly connected to the bus 1408.

The network 142.6 may include wireless networks, ethernet AVB networks, or combinations thereof. The wireless network may be a cellular telephone network, an 802.11, 802.16, 802.20, 802.1Q or WiMax network. Further, the network 1426 may be a public network, such as the Internet, a private network, such as an intranet, or combinations thereof, and may utilize a variety of networking protocols now available or later developed including, but not limited to transmission control protocol (TCP)/internet protocol (IP) based networking protocols. The system is not limited to operation with any particular standards and protocols. For example, standards for Internet and another packet switched network transmission (e.g., TCP/IP, User datagram protocol (UDP)IP, hypertext markup language (HTML), hypertext transfer protocol (HTTP)) may be used.

The present subject matter at least facilitates a preventive safety feature, with the intent of creating a behavioral change in the users. While the overlay does not hamper the user's ongoing activity, it nudges the user enough to alter their activity rather than impose the same. In addition, the user may be warned through a more specific overlay, in case of involvement in a more dangerous activity like watching videos while walking, thereby preventing the user from a risky mobile device usage

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The scope of embodiments is by no means limited by these specific examples. Numerous variations, whether explicitly given in the specification or not, such as differences in structure, dimension, and use of material, are possible.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for providing alerts in a computing device, the method comprising:
determining usage of the computing device based on a user interaction;
ascertaining whether the user is exhibiting a foot movement;
displaying an overlay of a predetermined size for a predetermined amount of time to cause an alert, in response to the ascertainment and the determination; and
incrementing a size of the displayed overlay linearly with time, based on persistence of the usage and the exhibition of the foot movement beyond an extended time duration.

2. The method of claim 1, further comprising:
displaying the overlay across an entire screen of the computing device for a duration based on the persistence of the usage and the exhibition of the foot movement beyond a threshold time duration; and
after the flashing of the overlay persisting across the entire screen for the duration, displaying the overlay with the size displayed prior to the displaying of the overlay across the entire screen of the computing device for the duration.

3. The method of claim 1, wherein the overlay being displayed in a plurality of sizes based on the incremented sizes facilitates the alerting through multi-sized overlays, based on the continuous persistence of the usage and the exhibition of the foot movement.

4. The method of claim 1, further comprising:
storing a screen position of the displayed overlay in a database;
fetching the stored screen position of the overlay from the database; and
rendering the overlay at the fetched screen position.

5. The method of claim 1, wherein the usage of the computing device based on the user interaction is determined through capturing at least one of:
a duration of the user's gaze towards a location at a screen area;
a number of the user's eye blinks while the user is viewing the screen area;
a user input received through a keypad;
an audio/video being rendered at the computing device; or
performance of communication by the user through the computing device.

6. The method of claim 1, wherein the ascertainment of the foot movement is enabled by at least one of motion sensors, an accelerometer, a pedometer, a global positioning system (GPS), or a combination thereof within the computing device.

7. The method of claim 6, wherein the ascertainment of the foot movement comprises differentiating the user's motion from a vehicle imparted motion based on at least one of:
detecting a footstep count and geographical coordinates corresponding to the user;
capturing the user's footstep pattern as executed among at least one of walking, running, jogging, or driving;
determining the user's gait based on a footstep count; or
utilizing a location based application programming interface (API) to detect the user's travel in a moving vehicle and ignoring, at least partly, the footsteps as exhibited by the user during the vehicle movement.

8. The method of claim 1, further comprising:
classifying a number of steps executed through the foot movement during at least one of:
absence of the usage of the computing device as part of the user interaction as safe steps; or
persistence of the usage of the computing device through the user interaction as unsafe steps.

9. The method of claim 8, further comprising:
designating the user of the computing device based on a number of the safe steps exceeding a threshold.

10. The method of claim 1, further comprising:
modifying a representation of incoming notifications within the computing device based on the persistence of the usage through the user interaction and the exhibition of the foot movement.

11. The method of claim 1, further comprising:
after displaying the overlay, allowing the user to momentarily suspend the display of the overlay, based on receiving the user input.

12. The method of claim 1, wherein, in response to the ascertainment and the determination, performing through the computing device at least one of:
informing the user about a surrounding geographical area;
filtering information presented through the computing device to reduce user distraction;
modifying the display to enable see through viewing so as to give an appearance of seeing through the computing device;
modifying the user interface to reduce user input;
automatically triggering one or more functionalities; or
momentarily restricting one or more functionalities.

13. The method of claim 1, wherein the display of the overlay is accompanied by at least one of:
allowing the computing device's operations during the exhibition of the foot movement executed under one or more first type of scenarios;
blocking the computing device's operations during the exhibition of the foot movement executed under one or more second type of scenarios;
depiction of one or more shortlisted functionalities of the computing device at the screen area; or
modification of a format of information displayed by the computing device to cause an expedited conveyance of information to the user.

14. A system for providing alerts in a computing device, the system comprising:
a display;
a memory storing instructions; and
at least one processor electrically coupled with the display and the memory, and configured to execute the instructions,
wherein the instructions, when executed east one processor, causes the at least one processor to control to:
determine usage of the computing device based on a user interaction;
ascertain whether the user is exhibiting a foot movement;
display an overlay of a predetermined size for a predetermined amount of time to cause an alert, in response to the ascertainment and the determination; and
increment a size of the displayed overlay linearly with time, based on persistence of said usage and the exhibition of the foot movement beyond an extended time duration.

15. The system of claim 14, wherein the instructions, when executed by the at least one processor, further causes the at least one processor to control to:
displaying the overlay across an entire screen of the computing device for a duration based on the persistence of the usage and the exhibition of the foot movement beyond a threshold time duration; and
after the flashing of the overlay being present across the entire screen for the duration, displaying the overlay with the size displayed prior to the displaying of the overlay across the entire screen of the computing device for the duration.

16. The system of claim 14, wherein the instructions, when executed by the at least one processor, further causes the at least one processor to control to:
store a screen position of the displayed overlay in a database;
fetch the stored screen position of the overlay from the database; and
render the overlay at the fetched screen position.

17. The system of claim 14, wherein the instructions, when executed by the at least one processor, causes the at least one processor to control to determine the usage of the computing device through capturing at least one of:
a duration of the user's gaze towards a location at a screen area;
a number of the user's eye blinks while the user is viewing the screen area;
a user input received through a keypad;
an audio/video being rendered at the computing device; or
performance of communication by the user through the computing device.

18. The system of claim 14, wherein the instructions, when executed by the at least one processor, causes the at least one processor to control to ascertain the foot movement through at least one of motion sensors, an accelerometer, a pedometer, a global positioning system (GPS), or a combination thereof within the computing device.

19. The system of claim 14, wherein the instructions, when executed by the at least one processor, further causes the at least one processor to control to modify a representation of incoming notifications within the computing device based on the persistence of the usage through the user interaction and the exhibition of the foot movement.

20. The system of claim 14, wherein the instructions, when executed by the at least one processor, further causes the at least one processor to control to, in response to the ascertainment and the determination, perform of at least one of:
informing the user about a surrounding geographical area;
filtering information presented through the computing device to educe user distraction;
modifying the display to enable see through viewing so as to give an appearance of seeing through the computing device;
modifying the user interface to reduce user input;
automatically triggering one or more functionalities; or
momentarily restricting one or more functionalities.
